(19) United States
(12) Patent Application Publication
(10) Pub. No.: US 2022/0399797 A1
(43) Pub. Date: Dec. 15, 2022

(54) Self-Sustaining Electricity Generation System

(71) Applicant: Jamie Kirchner, Albany, NY (US)

(72) Inventor: Jamie Kirchner, Albany, NY (US)

(21) Appl. No.: 17/345,038

(22) Filed: Jun. 11, 2021

(51) Int. Cl. H02K 53/00; H02P 9/04

(52) U.S. Cl. CPC H02K 53/00; H02P 9/04

(57) ABSTRACT

This invention is a self-sustaining, primary source of electricity for residential use, electric vehicle (EV) integration for automated self-charging, and various mobile applications. An electric motor mechanically turns compactly arranged AC PM generator rotor shafts by the use of a belt and pulley system. The electrical output of the AC PM generators is stored in an external 48V primary battery system which, in turn, provides power to the electric motor. A programmable system controller monitors the state of charge of the 48V primary battery system and other electrical components and automatically powers or stops the electric motor according to programmed upper and lower limits. The programmable system controller monitors all functions of the generator system and performs necessary actions to perpetuate operation of the self-sustaining electricity generation system.

### BACKGROUND OF THE INVENTION

### Field of Invention

This invention pertains to electricity generation systems. More specifically, this invention pertains to a self-sustaining, automated, belt-driven electricity generation system.

### Description of the Related Art

Residential electricity is typically supplied by the electric grid or from small-scale wind power systems, small-scale solar power systems, or a combination of grid, wind, and solar. If the grid is damaged as a consequence of severe weather events or natural disasters and power is lost, there may be extended time needed for the grid to be repaired and power to be restored. If the consumer has on-site battery storage it may or may not provide sufficient electricity to fully endure the power outage. Small-scale wind and solar systems also require installation of equipment on the exterior of each residence which exposes that equipment to the same severe weather events and natural disasters that the electric grid is vulnerable to.

Maintenance of the electric grid and delivery costs of electricity from the electric grid are paid by consumers and often account for half or more than half of a monthly electric bill. The consumer has no control over the operation of the utility company and is unable to do anything to reduce the costs of operating the company that services their area. If the utility company is poorly managed or excessively expensive, the consumer ultimately pays for it.

Backup generators that are currently available to consumers require a fuel source, emit exhaust, and produce excessive noise. These generators depend on gasoline, propane, or another fuel source to provide emergency short-term electricity but are inadequate to function as a primary source of electricity for a residence unless the consumer is willing to continuously fuel the generator. Due to the emission of exhaust, currently available generators must be installed outdoors or employ a method of venting exhaust to open air. The noise levels that are produced by these generators could be described as a nuisance and require outdoor placement.

There are applications beyond residential electricity that currently require energy to be provided by the electric grid or another external power or fuel source. Electric vehicles (EV) require battery charging from an external power source, whether from a charging system installed at a residence or publicly accessible charging stations. Consumers who do not have EV charging capabilities at their residence must be willing to wait with their EV at a charging station while it is charging or leave the vehicle charging and return when they estimate or are notified that the vehicle battery system is sufficiently charged. Charging access is a potential barrier to EV ownership. Building more infrastructure in the form of publicly accessible charging stations does not fully solve this problem. An alternative charging method is needed.

A machine that serves as a primary electricity source for residential electricity that is self-sustaining, emits no exhaust, is programmable, automated, and self-correcting is a needed alternative to the electric grid or other external power or fuel sources. If a method for generating electricity were embodied in a machine that could be installed inside a residence it would be protected by the structure of the building which would mitigate potential weather-related power losses for the residence year-round. Consumers should also have control over the cost they pay for residential electricity and a method for producing electricity independently without being forced to pay for plant maintenance and distribution is a needed alternative. A machine of this capability could also be interfaced with the electronics of an EV to monitor the state of charge of the EV battery system and automatically initiate charging when needed, regardless of whether the vehicle is occupied or unoccupied. A primary, independent source of power that can be used to power a residence, can be mobilized, or automate self-charging of EVs is a needed advance of technology.

### BRIEF SUMMARY OF THE INVENTION

This invention is a self-sustaining electricity generation system that can be used in residential, electric vehicle (EV) integration, and various other mobile applications. An electric motor mechanically turns the rotor shafts of compactly arranged alternating current (AC) permanent magnet (PM) generators by the use of a belt and pulley system. The AC PM generators are modified to reduce cogging torque which reduces the effort needed by the electric motor to rotate the rotor shafts of the AC PM generators. The electrical output of the AC PM generators is stored in an external 48V primary battery system which, in turn, provides power to the electric motor. A programmable system controller with an integrated intelligent motor control (IMC) center and integrated battery management system (BMS) monitors the state of charge of the primary battery system and automatically provides power to the electric motor when the state of charge reaches a programmed lower limit. When the state of charge of the primary battery system reaches a programmed upper limit, the programmable system controller automatically stops the electric motor and continues to monitor the primary battery system state of charge. The programmable system controller also continuously monitors and controls the functioning of the electric motor, a converter, an inverter, AC and DC circuit breakers, a secondary battery, a solar panel, temperature sensors, electric cooling fans, a step-up transformer, an electronic power supply switch, and belt slip sensors. This system is self-sustaining, programmable, automated, self-correcting, and does not emit exhaust.

### DESCRIPTION OF DRAWINGS

FIG. 1 is a rear view that shows the compactly arranged AC PM generators (5) and AC induction motor (4). The belts (2), pulleys (1), belt tensioners (3), and belt routing are a depiction of one possible configuration of these components and embodiment of the self-sustaining electricity generation system. A side view of the solar panel (23) is visible on the top of the chassis (6). In residential and EV applications, the solar panel (23) can be detached and mounted in a window.

1 Pulleys

2 Belts

3 Belt tensioners

4 AC induction motor

5 AC PM generators

6 Chassis

23 Solar panel

FIG. 2 is a representation of the rear view with the shell (8) installed and concealing the components that are visible in FIG. 1. A large vent (7) for airflow occupies much of the surface area of the shell (8). A side view of the solar panel (23) is visible on the top of the chassis (6).

6 Chassis

7 Vent

8 Shell

23 Solar panel

FIG. 3 is a representation of the front view that shows the AC circuit breaker (9), DC circuit breaker (10), programmable system controller (11), AC to DC inverter (12), a steel plate (19), secondary battery (22), and solar panel (23). A side view of the solar panel (23) is visible on the top of the chassis (6).

6 Chassis

9 AC circuit breaker

10 DC circuit breaker

11 Programmable system controller

12 AC to DC inverter

19 Steel plate

22 Secondary battery

23 Solar panel

FIG. 4 is a representation of the front view with the shell (8) installed and concealing the components that are visible in FIG. 3. A vent (7), the user interface touchscreen (13), 240 VAC GFCI outlets (15), 240 VAC GFCI system output port (16), AC and DC circuit breaker panel (17), and grounding post (28) are visible. A side view of the solar panel (23) is visible on the top of the chassis (6). A 48V DC GFCI output port (25) is used for EV and some mobile applications.

6 Chassis

7 Vent

8 Shell

13 User interface touchscreen

15 240 VAC GFCI outlets

16 240 VAC GFCI system output port

17 AC and DC circuit breaker panel

23 Solar panel

25 48V DC GFCI output port

28 Grounding post

FIG. 5 is a representation of one side that shows the profile of the AC induction motor (4), AC PM generators (5), and steel plate (19) on the right side of the image with belts (2) installed on the pulleys (1). FIG. 5 also shows the DC to AC inverter (12), AC to DC converter (20), programmable system controller (11), and steel plate (19) on the left side of the image. A side view of the solar panel (23) is visible on the top of the chassis (6).

1 Pulleys

2 Belts

4 AC induction motor

5 AC PM generators

6 Chassis

11 Programmable system controller

12 DC to AC inverter

19 Steel plate

20 AC to DC converter

23 Solar panel

FIG. 6 is a representation of the same side view as FIG. 5 with the shell (8) installed. The electric fans (21) are visible. A side view of the solar panel (23) is visible on the top of the chassis (6).

6 Chassis

8 Shell

21 Fans

23 Solar panel

FIG. 7 is a representation of the opposite side view from FIG. 5 that shows the profile of the AC induction motor (4), AC PM generators (5), and steel plate (19) on the left side of the image with belts (2) installed on the pulleys (1). FIG. 7 also shows the DC to AC inverter (12), AC to DC converter (20), programmable system controller (11), step-up transformer (18), and steel plate (19), AC circuit breaker (9), and secondary battery (22) on the right side of the image. A side view of the solar panel (23) is visible on the top of the chassis (6).

1 Pulleys

2 Belts

4 AC induction motor

5 AC PM generators

6 Chassis

9 AC circuit breaker

11 Programmable system controller

12 DC to AC inverter

18 Step-up transformer

19 Steel plate

20 AC to DC converter

22 Secondary battery

23 Solar panel

FIG. 8 is a representation of the same side view as FIG. 7 with the shell (8) installed and concealing the components that are visible in FIG. 7. The electric fans (21) are visible. A side view of the solar panel (23) is visible on the top of the chassis (6).

6 Chassis

8 Shell

21 Fan

23 Solar panel

FIG. 9 is a hybrid diagram of the cyclical connection of components, direction of electrical output from component to component, and connectivity of the programmable system controller (11) to each component that is monitored and controlled by the programmable system controller (11). Beginning with the 48V primary battery system (24), electricity feeds the DC to AC inverter (12). AC output from the DC to AC inverter (12) feeds the AC circuit breaker (9). The AC circuit breaker (9) feeds a step-up transformer (18) that adjusts voltage and feeds the 240 VAC GFCI outlets (15) and 240 VAC GFCI system output port (16). The AC output from the AC circuit breaker (9) also feeds the programmable system controller (11). The programmable system controller (11) feeds the AC induction motor (4).

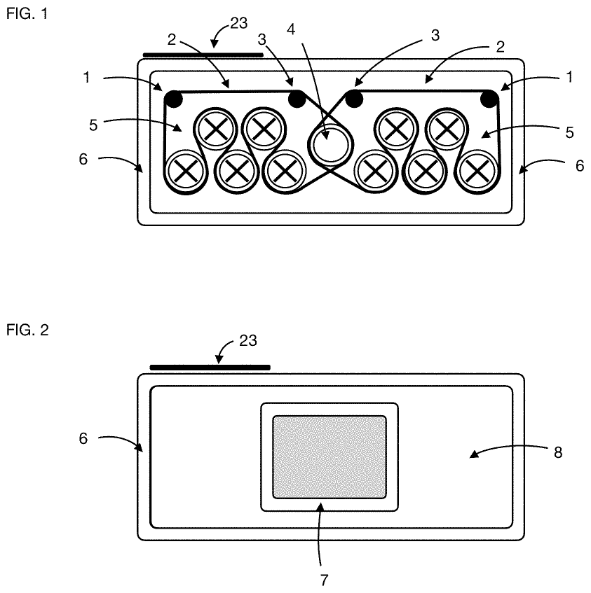

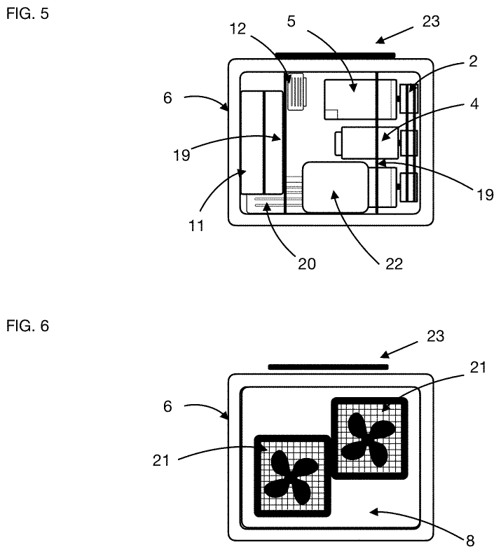

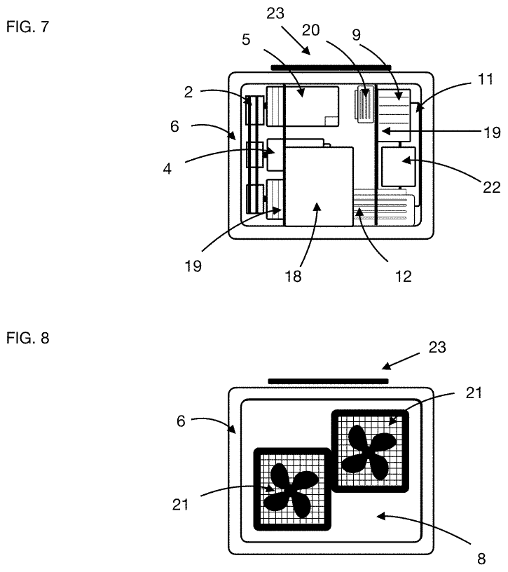

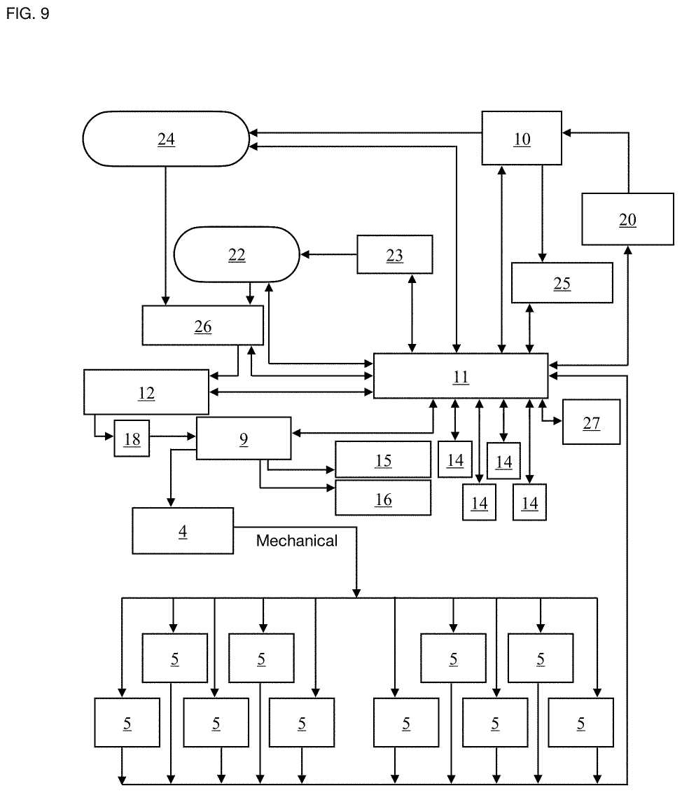

The AC induction motor (4) mechanically rotates the AC PM generator (5) rotor shafts by use of belts (2) and pulleys (1) depicted in FIGS. 1, 5, and 7. Belt slip sensors (14) detect whether a belt (2) is slipping, dismounted, or broken. The AC output from each of the AC PM generators (5) is individually fed to the programmable system controller (11) where the individual voltage and current from each AC PM generator (5) is measured, the output from all AC PM generators (5) is combined and the voltage and current are regulated. The regulated AC output from the programmable system controller (11) feeds an AC to DC converter (20). The DC output from the AC to DC converter (20) passes through a DC circuit breaker (10) before power is stored in the primary battery system (24).

The programmable system controller (11) continuously monitors the state of charge of the primary battery system (24) and the operation of the AC circuit breaker (9), DC circuit breaker (10), DC to AC inverter (12), AC to DC converter (20), electronic power supply switch (26), and the temperature sensors (27).

As a contingency, the solar panel (23) and secondary battery (22) are monitored by the programmable system controller (11) that activates an electronic power supply switch (26) to select power from the 48V primary battery system (24) or the secondary battery (22). Either the 48V primary battery system (24) or the secondary battery (22) feeds the AC induction motor (4) according to the action of the programmable system controller (11). A 48V DC GFCI output port (25) is used for EV applications and can be used for some mobile applications.

1 Pulleys

2 Belts

4 AC induction motor

5 AC PM generators

9 AC circuit breaker

10 DC circuit breaker

11 Programmable system controller

12 DC to AC inverter

14 Belt slip sensors

15 240 VAC GFCI outlets

16 240 VAC GFCI system output port

18 Step-up transformer

20 AC to DC converter

22 Secondary battery

23 Solar panel

24 48V primary battery system

25 48V DC GFCI output port

26 Electronic power supply switch

27 Temperature sensor

### DETAILED DESCRIPTION OF INVENTION

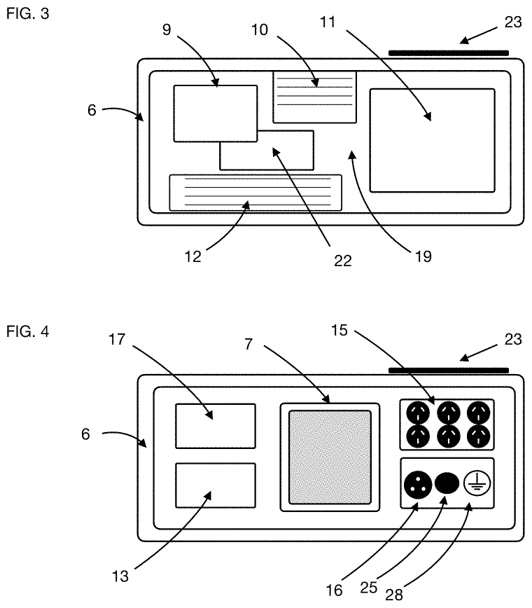

This invention is a self-sustaining electricity generation system and the embodiment of that system which is programmable, emits no exhaust, requires no fuel, and can be used in residential, electric vehicle (EV) integration for automated self-charging capability, as well as various other mobile applications. This system comprises a cyclical process with mechanical and electrical components that work in tandem to generate electricity which is stored in an external 48V primary battery system (24) in a variety of possible embodiments. One embodiment of the self-sustaining electricity generation system is depicted in FIGS. 1 through 8. A minimal amount of the energy stored in the 48V primary battery system (24) powers an alternating current (AC) induction motor (4) that rotates the rotor shafts of a plurality of AC permanent magnet (PM) generators (5). The specifications of the AC induction motor (4) and the AC PM generators (5) are variable and are matched for efficiency—according to the application—to minimize the amount of electricity needed to power the self-sustaining electricity generation system, reduce energy lost as heat by the AC induction motor (4) and other components, and to rotate the AC PM generator (5) rotor shafts at the desired speed for optimal electrical output. The AC output voltage, current, and frequency in residential applications and DC output voltage and current in EV and mobile applications are regulated by the programmable system controller (11).

Although PM generators typically depend on air, steam, wind, water, gas, or another medium to rotate a revolving shaft or rotor and produce power, a fundamental operation of the self-sustaining electricity generation system is the use of an AC induction motor and system of belts (2) and pulleys (1) to rotate the rotor shafts of modified AC PM generators (5). The necessary modification of the AC PM generators (5) is the reduction of cogging torque to minimize the force needed by the AC induction motor (4) to mechanically turn the AC PM generator (5) rotor shafts. Any effective method or combination of methods may be used to achieve the objective of reducing cogging torque. Other components facilitate the electrical and mechanical processes that enable the self-sustaining electricity generation system to operate and produce electrical output.

An external 48V primary battery system (24) that is provided by the consumer concurrently stores the electrical output of the self-sustaining electricity generation system and supplies power to the self-sustaining electricity generation system. The particular battery technology of the 48V primary battery system (24) has no impact on the basic operation of the self-sustaining electricity generation system. However, advancing battery technology is at the disposal of the end-user and selecting a battery technology with a faster charging time would increase the efficiency of the self-sustaining electricity generation system.

As a cyclical method, any point in the process can be used as a starting point to begin explaining the full cycle. Beginning with the 48V primary battery system (24), electricity is fed to a high-efficiency DC to AC inverter (12). The efficiency of the DC to AC inverter is critically important for the self-sustaining electricity generation system as a component where the greatest potential loss of power can be prevented and the overall efficiency of the system can be preserved. The AC output of the DC to AC inverter (12), at 60 Hz or 50 Hz—according to the application—passes through an AC circuit breaker (9). The AC circuit breaker (9) is mounted to the chassis (6) next to the DC circuit breaker (10) with the AC and DC breaker panel (17) flush with the exterior of the shell (8) for accessibility. The AC circuit breaker (9) AC output feeds a step-up transformer (18) that increases output voltage for the 240 VAC GFCI outlets (15) and 240 VAC GFCI system output port (16). The AC circuit breaker (9) AC output also feeds the programmable system controller (11). For EV and some mobile applications, AC output from the programmable system controller (11) flows through the AC to DC converter (20) and DC circuit breaker (10) before feeding a 48V DC GFCI output port (25). In EV applications there is an interface between the programmable system controller (11), the vehicle electronic control unit (ECU), and vehicle battery management system (BMS). The interface of the programmable system controller (11) with EV ECUs and BMSs coupled with the electrical output of the self-sustaining electricity generation system enables and facilitates automated self-charging of EVs.

The programmable system controller (11) comprises an integrated intelligent motor control (IMC) center with an integrated battery management system (BMS). The programmable system controller (11) uses the integrated IMC and integrated BMS to monitor performance, gather data, and perform actions to control the AC induction motor (4), the plurality of AC PM generators (5), the AC circuit breaker (9), the DC circuit breaker (10), the DC to AC inverter (12), the user interface touchscreen (13), the belt slip sensors (14), the 240 VAC GFCI outlets (15), the 240 VAC GFCI system output port (16), the AC and DC circuit breaker panel (17), the step-up transformer (18), the AC to DC converter (20), the electric fans (21), the secondary battery (22), the solar panel (23), the 48V primary battery system (24), the 48V DC GFCI output port (25), the electronic power supply switch (26), and the temperature sensors (27). The programmable system controller (11) performs all motor control functions according to the information that has been gathered including regulating startup torque and regulating motor speed with variable frequency control. The programmable system controller (11) integrated BMS regulates the voltage and current it receives from the AC PM generators (5) before feeding the AC to DC converter (20). The 48V DC output from the AC to DC converter (20) feeds the DC circuit breaker (10). The DC circuit breaker (10) feeds power to the 48V primary battery system (24).

The programmable system controller (11) IMC feeds power to the AC induction motor (4) at the appropriate voltage per frequency ratio (V/Hz) for the motor. The AC induction motor (4) mechanically rotates the AC PM generator (5) rotor shafts by use of a system of belts (2) and pulley (1) depicted in FIGS. 1, 5, and 7. Four separate belts (2) are used with two belts (2) configured to rotate the rotor shafts of the first group of AC PM generators (5) and the remaining two belts (2) configured to rotate the rotor shafts of the second group of AC PM generators (5). The failure of a single belt (2) will not disable the self-sustaining electricity generation system and will allow time for service without a power outage for the consumer.

The solar panel (23) and secondary battery (22) are a contingencies that enable the self-sustaining electricity generation system to self-correct if the primary battery system (24) has a depleted state of charge. The solar panel (23) is only used to ensure that the secondary battery (22) is fully charged and ready for use if it is needed. The secondary battery (22) is only used to provide power if the self-sustaining electricity generation system when it is self-correcting.

The programmable system controller (11) monitors the state of charge of the 48V primary battery system (24) and automatically feeds power to the AC induction motor (4) when the state of charge reaches a programmed lower limit. When the state of charge of the 48V primary battery system (24) reaches a programmed upper limit, the programmable system controller (11) automatically stops the AC induction motor (4) and continues to monitor the 48V primary battery system (24) state of charge. The programmable system controller (11) is programmed for optimal charging according to the specifications from the battery manufacturer to prolong the life cycle of the 48V primary battery system (24).

In an unlikely, but possible, scenario when the 48V primary battery system (24) has a depleted state of charge, the programmable system controller (11) changes the power source to the secondary battery (22) by activating the electronic power supply switch (26). The secondary battery (22) then feeds power to the AC induction motor (4) to mechanically turn the AC PM generator (5) rotor shafts and the AC output from the AC PM generators (5) enters the programmable system controller (11). If the secondary battery (22) is in use, the 240 VAC GFCI outlets (15), 240 VAC GFCI system AC output port (16), and 48V DC GFCI output port (25) are temporarily disabled by the programmable system controller (11) to accelerate charging of the 48V primary battery system (24). The AC output of the programmable system controller (11) feeds the AC to DC converter (20) and DC circuit breaker (10) before charging the 48V primary battery system (24).

Once the 48V primary battery system (24) reaches a programmed acceptable minimal state of charge to power the self-sustaining electricity generation system, the programmable system controller (11) switches the power supply from the secondary battery (22) to the 48V primary battery system (24) by use of the electronic power supply switch (26). After switching the power source from the secondary battery (22) to the 48V primary battery system (24), the programmable system controller (11) enables the 240 VAC GFCI outlets (15) and 240 VAC GFCI system output port (16) or 48V DC GFCI output port (25), depending upon the application, and continues to monitor the state of charge of the 48V primary battery system (24) and secondary battery (22). The programmable system controller (11) creates an alert notification that is displayed on the user interface touch screen (13) to service the system if either the 48V primary battery system (24) or secondary battery (22) is not functioning according to programmed parameters. Cellular or wireless internet hardware can be added to facilitate functionality, efficiency, and service communications directly with the consumer or with a service company.

The programmable system controller (11) routinely measures the input and output voltage and current for each AC PM generator (5). It is necessary to employ a plurality of PM generators (5) to ensure that the self-sustaining electricity generation system will continue to operate and produce electrical output whether one AC PM generator (5) fails or multiple AC PM generators (5) fail. In a scenario when an individual AC PM generator (5) is determined to have incorrect output voltage or current, that individual AC PM generator (5) is automatically disabled. If multiple AC PM generators (5) malfunction, they are each automatically disabled. The self-sustaining electricity generation system will continue to produce power after disabling one or multiple AC PM generators (5). The result of disabling one or multiple AC PM generators (5) would be changed voltage and current of the combined output of the plurality of AC PM generators (5). However, the voltage output and current output of the plurality of AC PM generators (5) are regulated by the programmable system controller (11). The programmable system controller (11) adapts to the input voltage and current from the AC PM generators (5) to ensure that voltage and current are within programmed specifications before power is fed to the AC to DC converter (20). The programmable system controller (11) creates an alert notification that is displayed on the user interface touch screen (13) to service the system if one or multiple AC PM generators (5) is disabled.

The material used for the chassis (6) depicted in FIGS. 1 through 8 is steel for rigidity. The height, width, and depth of the chassis (6) may differ according to application. Applications in EV integration or EV retrofitting may require substantial modifications to the chassis (6) and configuration of components or elimination of the chassis (6) and integration with EV components to fit within the space limitations of EVs. The example embodiment of the self-sustaining electricity generation system illustrated in FIGS. 1 through 8 has the dimensions of 100 cm×40 cm×40 cm. Other mobile applications may use the same dimensions as the example embodiment in FIGS. 1 through 8 with wheels mounted directly to the chassis (6) or mounting of the chassis (6) to a trailer. The size of the chassis (6) is dependent on the specifications of the AC induction motor (4) and AC PM generators (5) employed and the space needed within the chassis (6) to accommodate adequate airflow for cooling.

Two steel plates (19) trisect the interior of the chassis (6) and serve the purposes of strengthening the chassis (6), providing mounting surfaces for the components, physically separating the components, and creating three chambers to facilitate airflow for cooling. Cooling is further accomplished by the use of four small electric fans (21) with two fans (21) on each end of the chassis (6) in a push-pull configuration to maximize airflow. The programmable system controller (11) monitors the self-sustaining electricity generation system temperature by use of temperature sensors (27) positioned in proximity to components. Fan (21) speed is increased by the programmable system controller (11) to maximize airflow and cooling according to a programmed temperature range and fan (21) speed is reduced or the fans (21) are turned off by the programmable system controller (11) to conserve energy usage if cooling isn't needed.

A grounding post (28) on the exterior of the chassis (6) enables the connection to a grounding rod if it is required or becomes required according to the NEC. The chassis (6) is constructed with steel to meet NEC bonding/grounding requirements and the design may be modified if composite or other alternative materials are permitted in accordance with current or amended NEC bonding/grounding requirements.

The outer shell (8) is molded, vented (7), impact-resistant, fire-rated plastic. Vents (7) in the shell (8) facilitate greater air circulation and increased cooling efficiency. Fire, heat, and moisture-resistant sound dampening materials are used on the interior surfaces of the chassis (6) and shell (8) to reduce risk of fire and mold and to reduce noise when the AC induction motor (4) and AC PM generators (5) are operating.

In residential power applications, the 48V primary battery system (24) is electrically connected to the residential circuit breaker by the use of a commonly available generator transfer switch.

Inventor claims:

1. A self-sustaining electricity generation system that comprises: electrical and mechanical components that function individually and in concert with other components in a process to generate electricity.

2. The self-sustaining electricity generation system in claim 1, wherein an AC induction motor (4) mechanically rotates the rotor shafts of a plurality of AC PM generators (5) by use of a belt (2) and pulley (1) system.

3. The self-sustaining electricity generation system in claim 1, wherein the AC output from the plurality of AC PM generators (5) feeds a programmable system controller (11) that contains an integrated intelligent motor control (IMC) center and integrated battery management system (BMS).

4. The self-sustaining electricity generation system in claim 1, wherein the AC output from the programmable system controller (11) is converted to DC by use of an AC to DC converter (20).

5. The self-sustaining electricity generation system in claim 1, wherein the DC output from the AC to DC converter (20) passes through a DC circuit breaker (10).

6. The self-sustaining electricity generation system in claim 1, wherein the DC output from the DC circuit breaker (10) feeds a 48V primary battery system (24).

7. The self-sustaining electricity generation system in claim 1, wherein the DC output from the 48V primary battery system (24) feeds a DC to AC inverter (12).

8. The self-sustaining electricity generation system in claim 1, wherein the AC output from the DC to AC inverter (12) feeds a step-up transformer (18).

9. The self-sustaining electricity generation system in claim 1, wherein the AC output from the step-up transformer (18) passes through an AC circuit breaker (9).

10. The self-sustaining electricity generation system in claim 1, wherein the AC output from the AC circuit breaker (9) feeds a programmable system controller (11).

11. The self-sustaining electricity generation system in claim 1, wherein the AC output from the AC circuit breaker (9) feeds 240 VAC GFCI outlets (15) and a 240 VAC GFCI system output port (16).

12. The self-sustaining electricity generation system in claim 1, wherein the AC output from the AC circuit breaker (9) feeds an AC induction motor (4).

13. The self-sustaining electricity generation system in claim 1, wherein an electric motor (4) and a plurality of AC PM generators (5) are mechanically connected by a belt (2) and pulley (1) system that uses two belts (2) to rotate the rotor shafts of one grouping of the plurality of AC PM generators (5) and two belts (2) to rotate the second grouping of the plurality of AC PM generators (5) to total four belts (2).

14. The self-sustaining electricity generation system in claim 1, wherein an interface between the programmable system controller (11) and either an electric vehicle (EV) electronic control unit (ECU) or an EV battery management system (BMS) or an interface between the programmable system controller (11) and both an EV ECU and an EV BMS coupled with the electrical output of the self-sustaining electricity generation system enables and facilitates EV automated self-charging.

15. A programmable system controller that comprises: an integrated intelligent motor control (IMC) center with an integrated battery management system (BMS) that measures performance, gathers data, and performs actions necessary for the operation of the self-sustaining electricity generation system including regulating and controlling startup torque, electric motor speed with variable frequency control, and voltage and current supplied to the AC induction motor (4).

16. The programmable system controller in claim 15, wherein the performance of an AC induction motor (4), the plurality of AC PM generators (5), the AC circuit breaker (9), the DC circuit breaker (10), the DC to AC inverter (12), the user interface touchscreen (13), the belt slip sensors (14), the 240 VAC GFCI outlets (15), the 240 VAC GFCI system output port (16), the AC and DC circuit breaker panel (17), the step-up transformer (18), the AC to DC converter (20), the electric fans (21), the secondary battery (22), the solar panel (23), the 48V primary battery system (24), the 48V DC GFCI output port (25), the electronic power supply switch (26), and the temperature sensors (27) are monitored and data is collected.

17. The programmable system controller in claim 15, wherein either the 48V primary battery system (24) or secondary battery (22) is selected as the power source for the self-sustaining electricity generation system by controlling an electronic power supply switch (26).

18. The programmable system controller in claim 15, wherein an integrated battery management system (BMS) monitors a 48V primary battery system (24) and a secondary battery (22) for voltage, current, and state of charge.

19. The programmable system controller in claim 15, wherein the action of selecting a power source of either the primary battery system (24) or secondary battery (22) by activating the elecronic power supply switch (26) is performed.

20. The programmable system controller in claim 15, wherein the action of automatically providing power to or restricting power from an AC induction motor (4) according to programmed upper and lower state of charge limits is performed.
